(19) United States
(12) Patent Application Publication
(10) Pub. No.: US 2009/0206201 A1
(43) Pub. Date: Aug. 20, 2009

(54) AIRPLANE WITH COLLAPSIBLE CREW REST COMPARTMENT MODULES

(76) Inventors: Richard J. Johnson, Freeland, WA (US); Kim A. Miller, Everett, WA (US); Robert K. Rempel, Bothell, WA (US); Jeffrey R. Nix, Stanwood, WA (US); Gary W. Rickert, Shoreline, WA (US); David W. Eckert, Marysville, WA (US); Kathleen T. Delong, Everett, WA (US); Jeffrey D. Farnsworth, Marysville, WA (US)

Correspondence Address: OSTRAGER CHONG FLAHERTY & BROITMAN, P.C., 570 LEXINGTON AVENUE, FLOOR 17, NEW YORK, NY, 10022-6894, US

(21) Appl. No.: 11/380,483

(22) Filed: Apr. 27, 2006

(51) Int. Cl. B64D 11/06

(52) U.S. Cl. 244/118.6

(57) ABSTRACT

An improved crew rest area for a freighter airplane. The crew rest structure extends into the stay out zone between the crew or supernumerary accommodations and cargo areas and has one of more collapsible or crushable structures. The collapsible structures allow the areas in the stay out zones to collapse or be displaced when subjected to crash loads without impinging on the crew or supernumerary seating areas. The collapsible wall members or panels can be hinged, slidable, bendable in an accordion-type manner, or the like.

### TECHNICAL FIELD

The present invention relates to crew rest compartments on freighter airplanes, and more particularly to crew rest compartments with added accommodations and increased space in the crew rest area.

### BACKGROUND OF THE INVENTION

Other than military airplanes, the principal types of airplanes sold and in use today are either passenger airplanes or freighter airplanes. Also, some airplanes have the ability to be converted back and forth from passenger-type airplanes to freighter airplanes as desired. For this reason, the components of much of the interior architecture and structures of many airplanes are modular or removable. Of course, some airplanes are made strictly for the transportation of freight or cargo, or for passengers. An airplane that has had extensive use as a freighter or cargo airplane is the Boeing 747.

With freighter airplanes, the portions of the airplane and the space allowed for the pilots and the crew is limited. A crew rest compartment is typically positioned aft of the cockpit and can include a number of seats, as well as bunks or beds where the pilots and crew can rest during long overseas flights. Typically, a large area aft of the crew rest compartment is left unoccupied in the event that the cargo or other freight shifts forward during a minor crash, such as can occur during taxi, takeoff and landing. Typically, a cargo net is positioned immediately forward of the freight or cargo and the net will typically expand into the unoccupied area in the event of such crash. It is important in freighter airplanes to provide as much cargo space as possible for revenue purposes, while at the same time maximizing comfort and rest accommodations.

### SUMMARY OF THE INVENTION

It is an object of the present invention to provide an improved crew rest area for freighter airplanes. It is also an object of the present invention to provide a crew rest area with increased comfort and additional sleeping accommodations without losing any of the conventional seating capacity. It is a still further object of the present invention to use the empty volume behind the crew rest compartment and forward of the cargo net to provide additional crew rest area.

In accordance with the present invention, one or more “crushable” or “collapsible” structures are provided immediately behind the existing crew rest compartment and forward of the cargo net to provide additional crew rest area, particularly bed or bunk capacity. These areas, commonly called “stay-out areas”, cannot be occupied during taxi, takeoff and landing.

At least one additional room or structure is provided in the stay-out area which has panels or walls which are easily moveable or displaceable upon application of a force, such as by a load of cargo being pushed against it. Preferably, one or two crew bunks are maintained in this additional room or structure. There are a number of ways in which the walls or panels of the additional structure can be allowed to be displaced upon application of a force against them. The walls or panels can be positioned in such a manner that they slide over one another creating a smaller volume, the walls can be hinged or made in an accordion-type manner to allow collapsibility, or the panels can be telescopic relative to one another. It is also possible that the walls or panels can be made of a material that is easily destructible or broken apart by application of a large force, such as shift in a load of cargo against it.

### BRIEF DESCRIPTION OF THE DRAWINGS

FIG. 1 is a schematic view of a representative crew rest area for a freighter airplane.

FIG. 2 schematic illustrates an embodiment of a crew rest area in accordance with the present invention.

FIGS. 3A and 3B illustrate a step in the sequence of the collapsibility of a crew rest structure with the cargo net partially extended in accordance with the present invention.

FIGS. 4A and 4B illustrate another step in the crushability of a crew rest structure in accordance with the present invention.

FIGS. 5A and 5B illustrate still another step in the sequence of the crushability of a crew rest structure in accordance with the present invention.

### DESCRIPTION OF THE PREFERRED EMBODIMENT(S)

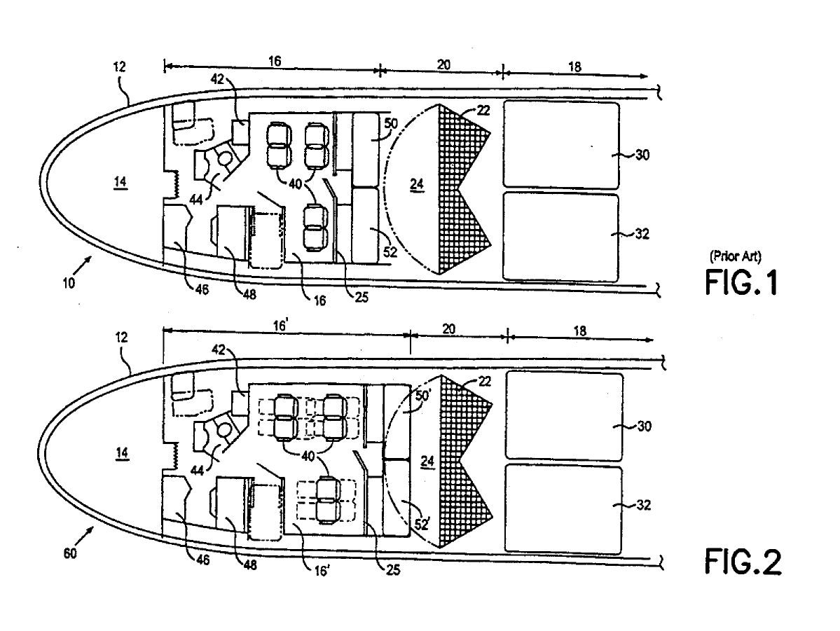

A typical crew rest compartment for a conventional freighter airplane is shown in FIG. 1 and indicated by their reference numeral 10. The external structure or skin of the airplane, only a portion of which is shown, is indicated by the reference numeral 12. The airplane 10 includes a cockpit area 14 where the pilots are situated, a crew rest area 16 and a cargo area 18 in which the cargo or freight is positioned. The area 20 situated between the crew rest compartment and the cargo area is considered a “stay out zone”, which cannot be occupied during taxi, takeoff, or landing. The type of crash in which the regulations are directed to is called a “minor crash”.

The cargo net area 22 is typically positioned in the zone 20 and is connected firmly around its perimeter to the structure of the airplane. The cargo net prevents the cargo or freight from sliding forward and impacting on the crew rest compartment in the event of a crash of the airplane during one of these conditions, namely taxi, takeoff, or landing. For this reason, the stay out zone 20 encompasses an additional area 24 which is provided to allow the cargo net 22 to expand and stretch in the event of a crash condition.

The cargo or freight is typically positioned in modular containers or on pallets, such as those shown in FIG. 1 as 30 and 32. The containers and/or pallets are typically 8 or 10 feet in height depending on the airplane in which they are positioned.

The partition 25 at the aft end of the seating area in the crew rest area 16 is a solid wall or panel. The crew and any passengers are positioned in front of partition 25 during taxi, takeoff, and landing.

As indicated, the present invention can be utilized in any type of airplane, whether it is being used in a cargo or freighter airplane condition Although the present invention has particular applicability for the upper deck of Boeing 747 Freighters or on the main deck for Boeing 777 Freighter airplanes, it is to be understood that the present invention can be used in any airplane.

In conventional freighter airplanes, the crew rest area can consist of a number of different areas. For example, the crew rest area can have a number of passenger seats 40 which are either used by the crew itself or any supernumeraries, who may be traveling along with the cargo. Typically, it is the pilots, copilots and navigators who use the crew rest compartment.

The crew rest area can have a shower 42, one or more bathrooms 44, one or more galleys 46, 48, and a number of sleeping areas such as 50 and 52. The sleeping areas typically have one or more beds, or bunk beds positioned one above the other.

An embodiment in accordance with the present invention is illustrated schematically in FIG. 2 and referred to generally by the reference numeral 60. Structural members or portions of the airplane which are the same as those illustrated in FIGS. 1 and 2 are designated by the same reference numerals. In this embodiment, however, the crew rest area 16′ is essentially the same as the crew rest area 16 as shown in FIG. 1, except that the crew rest 16′ extends further aft, allowing for increased seating comfort levels for the crew or supernumeraries that may be seated in that area. The collapsibility of the crew rest compartment in the position of the attachment of the net 22 would have to be such that none of the displaced or collapsed panels or walls is forced forward beyond the location of the partition wall 25.

It is also possible in accordance with the present invention to simply provide the same crew rest area as 16 as in FIG. 1 and position the cargo net 22 to a more forward position, and thus this would expand the area for cargo on the airplane, resulting in increased revenue.

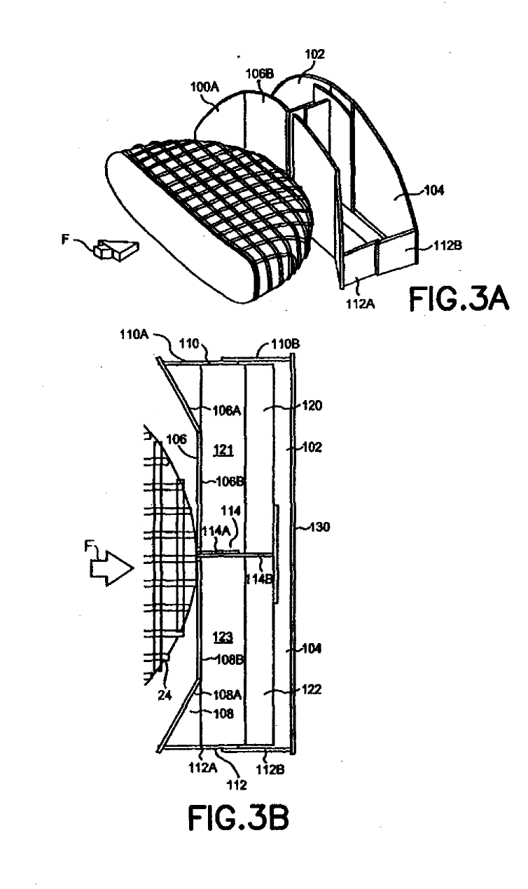

FIGS. 3A-3B, 4A-4B and 5A-5B illustrate various steps in the sequence of forward movement of the cargo and cargo net in the event of a crash situation and the resulting displacement or collapse of the walls or panels of the crew rest compartment in accordance with the present invention. In FIGS. 3A and 3B, which are merely a perspective and a plan view respectively of the same situation, the cargo has just started expanding into the collapsible bunking structures 102 and 104. The force F is the force caused by the moving cargo in the event of a crash.

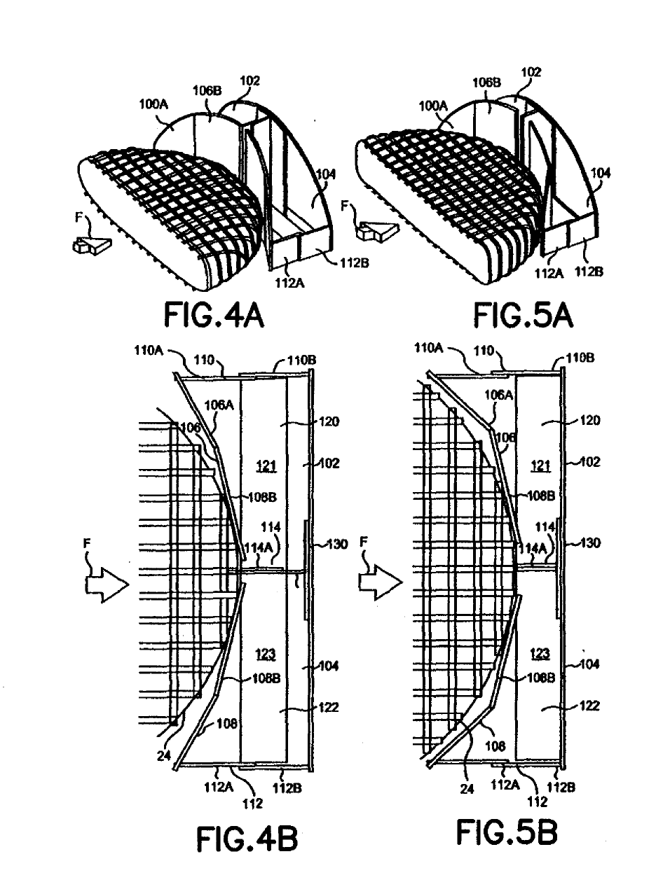

In FIGS. 4A and 4B which again are merely a perspective and a plan view of the same situation, the cargo net is further expanded and the cargo is further shifted forward in the airplane relative to the condition shown in FIGS. 3A and 3B.

Finally, in FIGS. 5A and 5B, the cargo net is in its fully extended position with FIGS. 5A and 5B being a perspective and a plan view of the same condition.

As shown in FIGS. 3A and 3B, the rear wall or panel partition 106 and 108 of the rest compartments 102 and 104 have foldable wall sections 106A-106B, and 108A and 108B, respectively. In addition, two end walls 110 and 112 are provided, along with a central wall or panel member 114. Each of the walls 110, 112 have two portions which are slidable relative to one another as shown. The benches or panel members 120 and 122 which are positioned underneath the mattresses 121 and 123, respectively, in the compartments 102 and 104, also are provided to be displaced. The bunk panel members 120 and 122 can be made of two slidable panels in the same manner as wall members 110, 112 and 114, or the panel members 120 and 122 can be adapted to be hinged upwardly against the inside wall member 130 in the event of a crash condition. The mattresses 121 and 123 themselves will be compressed by the forward movement of the cargo net 24 and can assist in absorbing some of the force of the crash.

FIGS. 4A and 4B, and then FIGS. 5A and 5B, show additional steps in the sequence of the collapsibility of the additional crew rest bunk compartments 102 and 104.

As indicated, there are various ways in which the panels or wall members of the crew rest structures can be made in a manner which allows them to be collapsed or be crushed in the event of an accident or crash and movement of the cargo and cargo net toward the front of the airplane. Other systems include the use of accordion-type wall members which allow at least the sidewall and central wall members of the crew bunk areas to easily collapse in a longitudinal manner along the length of the airplane. The wall members can also be made of a non-structural material which allows them to be easily broken apart in the event of being subjected to a considerable force.

When passengers or crew are positioned immediately forward of cargo, the Federal Aviation Authority (FAA) currently requires that the seated occupants are protected from the cargo during a minor crash. The effect is that cargo barriers, such as cargo nets, be designed to withstand the total weight of the aircraft's cargo multiplied by nine times the force of gravity (9 g's). Thus, the attachments between the net and the aircraft floor and fuselage must be capable of distributing that large load area into the aircraft's basic structure without impinging upon the crew rest areas forward of the partition 25.

While particular embodiments of the invention have been shown and described, numerous variations and alternative embodiments will occur to those skilled in the art. Accordingly, it is intended that the invention be limited only in terms of the appended claims.

1. A crew rest area for an airplane having a seating area forward of a solid partition wall, a cargo area aft said solid partition wall, said cargo area having an adjacent taxi, takeoff and landing stay-out area aft of said solid partition wall, wherein said stay-out area encompasses at least a portion of said crew rest area aft of said seating area and solid partition wall, said crew rest area having at least one sleeping enclosure with collapsible wall members wherein said sleeping enclosure has two collapsible side walls and an aft collapsible wall member, and all three sleeping enclosure wall members are collapsible in the event of a crash when contacted by moving cargo in the stay-out area of the airplane, and wherein said two side wall members each comprise a pair of wall panel members which are slidable relative to one another; wherein said aft wall member is comprised of at least two wall panel members hingedly connected together; and wherein said collapsible sleeping enclosure extends into said stay-out area and is displaced when subjected to crash loads without impinging on said solid partition wall and crew seating areas forward of said solid partition wall.

2. (canceled)

3. (canceled)

4. (canceled)

5. The crew rest area as described in claim 1 further comprising at least one bed member positioned in said sleeping enclosure, said bed member comprising a mattress support member which is collapsible.

6. The crew rest area as described in claim 1 further comprising at least one bed member positioned in said sleeping enclosure, said bed member comprising a mattress support member having at least two panel members slidable relative to one another.

7. A freighter airplane having at least a cockpit, a crew rest area, a taxi, takeoff and landing stay-out area, said stay-out area encompassing at least a portion of said crew rest area, a cargo area, and a cargo net positioned in said stay-out area, said crew rest area having a sitting area adjacent said cockpit and forward of a solid partition wall and at least a crew sleeping area adjacent said crew rest area, the improvements comprising at least one collapsible sleeping enclosure in said crew sleeping area aft of said solid partition wall and extending into said stay-out area, said sleeping enclosure has two side walls and an aft wall member, wherein all three wall members are collapsible, wherein said two side wall members each comprise a pair of wall panel members which are slidable relative to one another, wherein said aft wall member is comprised of at least two wall panel members hingedly connected together and wherein movement of cargo in said cargo area in a direction toward said crew rest area in the event of a crash, could force said collapsible sleeping enclosure to collapse without impinging on crew seating areas forward of said solid partition wall; and further comprising at least one bed member positioned in said sleeping enclosure, said bed member comprising a mattress support member which is collapsible.

8. (canceled)

9. (canceled)

10. (canceled)

11. (canceled)

12. The freighter airplane as described in claim 7 further comprising at least one bed member positioned in said sleeping enclosure, said bed member comprising a mattress support member having at least two panel members slidable relative to one another.

13. A freighter airplane as described in claim 7 wherein two collapsible sleeping enclosures are provided in said crew sleeping area immediately adjacent said stay-out area wherein said two collapsible sleeping enclosures have a common wall member between them, said common wall being collapsible and wherein said common wall member comprises two wall panel members slidable relative to one another.

14. (canceled)

15. (canceled)

16. A collapsible compartment for an airplane in event of a crash-type force being applied against the compartment, said collapsible compartment being aft of an adjacent crew seating area and having a solid partition wall therebetween, said collapsible compartment having two side wall members which comprise a pair of wall panel members which are slidable relative to one another and a rear wall member, all three wall members being collapsible, wherein said collapsible compartment extends into a taxi, takeoff and landing stay-out area of said airplane and is displaced when subjected to crash loads without impinging on said adjacent crew seating area; and further comprising at least one bed member positioned in said sleeping enclosure, said bed member comprising a mattress support member which is collapsible and having at least two panel members slidable relative to one another.

17. (canceled)

18. (canceled)

19. (canceled)

20. The collapsible compartment as described in claim 16 wherein two collapsible compartments are provided.
